(19) United States
(12) Patent Application Publication
(10) Pub. No.: US 2024/0338042 A1
(43) Pub. Date: Oct. 10, 2024

(54) TRANSPORT SYSTEM

(71) Applicant: HONDA MOTOR CO., LTD., Tokyo (JP)

(72) Inventors: Takashi Hashizume, Wako-shi (JP); Ryuichi Kimata, Tokyo (JP); Ryota Hisada, Tokyo (JP)

(73) Assignee: HONDA MOTOR CO., LTD., Tokyo (JP)

(21) Appl. No.: 18/746,207

(22) Filed: Jun. 18, 2024

Related U.S. Application Data
(63) Continuation of application No. PCT/JP2021/047924, filed on Dec. 23, 2021.

(51) Int. Cl. G05D 1/698; B60L 58/12; G05D 1/644; G05D 101/00; G05D 107/90; G06Q 10/0631

(52) U.S. Cl. CPC G05D 1/6987; G05D 1/644; G06Q 10/06315; B60L 58/12; G05D 2101/22; G05D 2107/90

(57) ABSTRACT

A transport system includes: a plurality of transport vehicles capable of autonomously moving between a departure place and a destination; a terminal used for inputting a transport request instruction including information about a plurality of transported objects to be respectively transported by the plurality of transport vehicles; and a server capable of communicating with the plurality of transport vehicles and the terminal. The server calculates priorities of the plurality of transported objects to be transported from the departure place to the destination, based on the transport request instruction, and assigns, in accordance with the priorities, the plurality of transport vehicles to respectively transport the plurality of transported objects from transport vehicles in a state of being capable of transporting, out of the plurality of transport vehicles, and outputs, at a predetermined timing, a movement instruction to each of the assigned plurality of transport vehicles.

### CROSS-REFERENCE TO RELATED APPLICATION(S)

This application claims priority to and the benefit of International Patent Application No. PCT/JP2021/047924 filed on Dec. 23, 2021, the entire disclosure of which is incorporated herein by reference.

### BACKGROUND OF THE INVENTION

### Field of the Invention

The present invention relates to a transport system.

### Description of the Related Art

Japanese Patent No. 6604846 relates to a vehicle operation management technique, and discloses a system in which, when a plurality of vehicles would enter an intersection at the same time or at times where they would be close to colliding, a control station determines priorities of the two vehicles, and decelerates a vehicle having a lower priority.

In addition, Japanese Patent No. 5984986 discloses a transport vehicle system for managing movements of a plurality of transport vehicles. In the transport vehicle system of Japanese Patent No. 5984986, in a case where an overlapping interference place is included on the way of movement routes scheduled by a plurality of transport vehicles, the priority of each transport vehicle is determined, and avoidance control is conducted by causing a transport vehicle having a lower priority to wait before movement.

In transporting a transported object from a departure place to a destination, when a large number of unmanned transport vehicles arrive at the destination at the same time, a predetermined time is needed for unloading work and the like, and congestion may occur in the destination. If a plurality of transport vehicles are on standby around the destination, it will not be possible to smoothly transport a transported object having a high priority to be necessary in the destination, in some cases.

In view of the above issues, the present invention provides a transport technique capable of assigning a transport vehicle in accordance with a priority of a transported object and outputting a movement instruction to provide a time difference in arrival time when the transport vehicle arrives at a destination.

### SUMMARY OF THE INVENTION

According to one aspect of the present invention, there is provided a transport system comprising: a plurality of transport vehicles capable of autonomously moving between a departure place and a destination; a terminal used for inputting a transport request instruction including information about a plurality of transported objects to be respectively transported by the plurality of transport vehicles; and a server capable of communicating with the plurality of transport vehicles and the terminal, the server comprising: a calculation unit configured to calculate priorities of the plurality of transported objects to be transported from the departure place to the destination, based on the transport request instruction; an assignment unit configured to assign, in accordance with the priorities, the plurality of transport vehicles to respectively transport the plurality of transported objects from transport vehicles in a state of being capable of transporting, out of the plurality of transport vehicles; and a movement control unit configured to output, at a predetermined timing, a movement instruction to each of the plurality of transport vehicles assigned by the assignment unit, wherein the movement control unit outputs the movement instruction to provide a preset time difference in arrival time when the plurality of transport vehicles arrive at the destination.

According to the present invention, it is possible to provide a transport technique capable of assigning a transport vehicle in accordance with a priority of a transported object and outputting a movement instruction to provide a time difference in arrival time when the transport vehicle arrives at a destination.

Further features of the present invention will become apparent from the following description of exemplary embodiments (with reference to the attached drawings).

### BRIEF DESCRIPTION OF THE DRAWINGS

FIG. 1 is a diagram illustrating a configuration example of a transport system according to an embodiment;

FIG. 2 is a block diagram of a transport vehicle according to an embodiment;

FIG. 3 is a diagram for describing a flow of processing in a server;

FIG. 4 is a diagram illustrating contents of a transport request instruction;

FIG. 5 is a diagram schematically illustrating a departure place, a destination, and a charging station;

FIG. 6 is a diagram illustrating a case where a plurality of transported objects are respectively transported to a plurality of destinations; and

FIG. 7 is a diagram schematically illustrating movement of each transport vehicle, based on a movement instruction.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

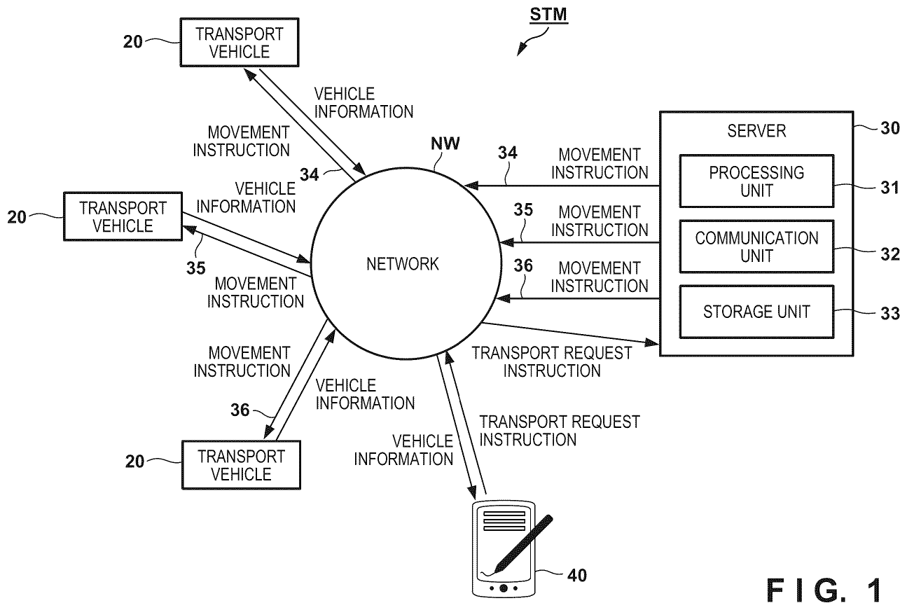

FIG. 1 is a diagram illustrating a configuration example of a transport system STM according to an embodiment, and the transport system STM includes at least a plurality of transport vehicles 20, a terminal 40, and a server 30. The plurality of transport vehicles 20 are autonomous transport vehicles capable of autonomously moving between a departure place and at least one destination. The terminal 40 is a terminal of an operator who manages the transport system STM, and is used for inputting transport request instructions respectively including information about transported objects to be transported by the plurality of transport vehicles 20. The server 30 (an information processing device) is configured to be capable of communicating with the plurality of transport vehicles 20 and the terminal 40 through a network NW.

The plurality of transport vehicles 20 are each an electric vehicle using a battery as a main power source, and vehicle information such as a battery remaining amount is transmitted to the server 30 and the terminal 40 through the network NW. In addition, base office terminals, not illustrated, in a departure place and a destination are connected to the network NW. For example, information about specific content of a transported object in a departure place, necessity or unnecessity of equipment (for example, a forklift truck or the like) necessary for an unloading process of the plurality of transported objects in the destination, and presence or absence of the equipment capable of handling the unloading process is transmitted from each base office terminal to the terminal 40. The terminal 40 acquires information that has been transmitted from each base office terminal, as information that constitutes a transport request instruction, and transmits the transport request instruction to the server 30.

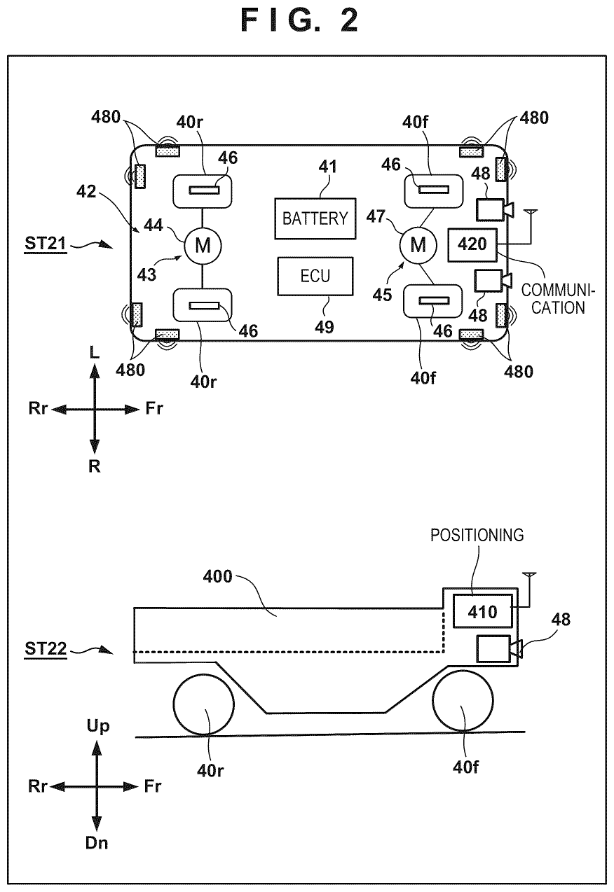

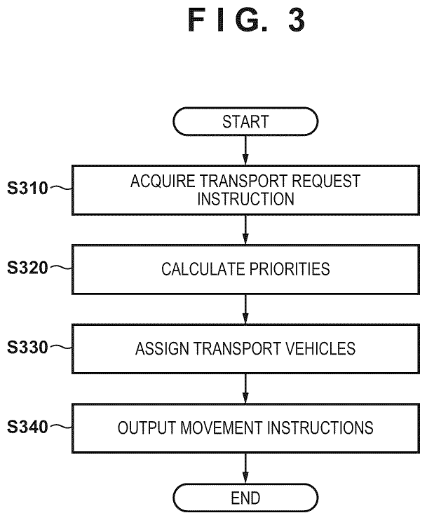

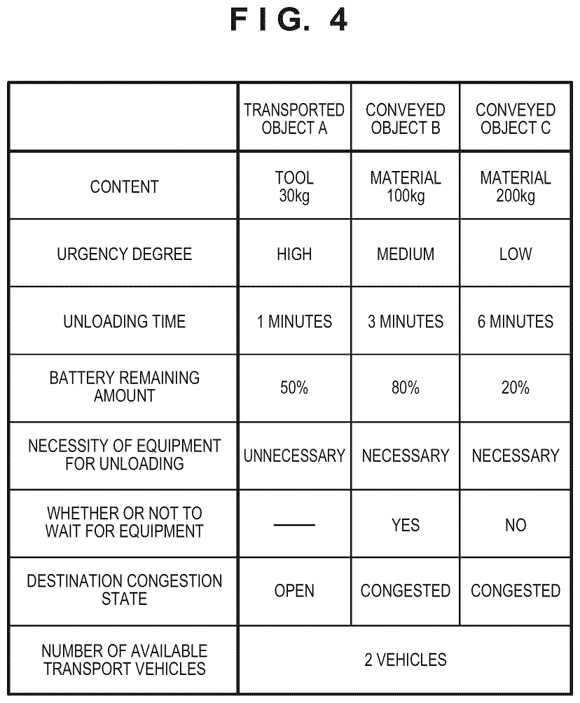

The server 30 calculates priorities of a plurality of transported objects to be transported from a departure place (a loading place of the transported objects) to a destination (a transport destination of the transported objects), based on the transport request instruction that has been acquired, assigns transport vehicles to respectively transport the transported objects in accordance with the priorities, and outputs movement instructions 34, 35, and 36 respectively to the plurality of transport vehicles 20 at predetermined timings. Here, the configuration of the transport vehicle 20 will be described with reference to FIG. 2, the transport request instruction will be described later with reference to FIG. 4, and the processing of the server 30 will be described with reference to FIGS. 3 and 5 to 7.

### (Transport Vehicle 20)

FIG. 2 is a block diagram of the transport vehicle 20 according to an embodiment of the present invention. ST21 is a plan view of the transport vehicle 20, and ST22 is a side view of the transport vehicle 20. In the drawing, Fr, Rr, L, and R respectively indicate front, rear, left, and right at the time when the transport vehicle 20 advances forward. In addition, Up and Dn respectively indicate an upper side and a lower side of the transport vehicle 20. The transport vehicle 20 is a vehicle capable of autonomously moving in a work area WA, is a vehicle that does not include a driver's seat or a driver's driving mechanism, and is unmanned during traveling. The transport vehicle 20 in the present embodiment is a four-wheeled vehicle including two front wheels 40f and two rear wheels 40r, carries cargos on a cargo bed 400, and transports the cargos.

The transport vehicle 20 is an electric vehicle using the battery 41 as a main power supply. The battery 41 is, for example, a secondary battery such as a lithium ion battery, and the transport vehicle 20 autonomously travels with electric power supplied from the battery 41. The transport vehicle 20 includes an electric traveling mechanism 42. The electric traveling mechanism 42 includes a traveling mechanism 43, a steering mechanism 45, and a braking mechanism 46.

The traveling mechanism 43 is a mechanism for moving the transport vehicle 20 forward or backward with the traveling motor 44 as a drive source. In the present embodiment, the rear wheels 40r are used as drive wheels. The braking mechanism 46 such as a disc brake is provided on each of the front wheels 40f and the rear wheels 40r.

The steering mechanism 45 is a mechanism for giving a steering angle to the front wheels 40f with the steering motor 47 as a drive source. Note that the electric traveling mechanism 42 in the present embodiment may include a two-wheeled steering mechanism that steers only the front wheels 40f, or may include a four-wheeled steering mechanism that steers the front wheels 40f and the rear wheels 40r.

The transport vehicle 20 includes a detection unit 480, which detects a surrounding situation. The detection unit 480 is an external sensor group that monitor surroundings of the transport vehicle 20. The external sensor is, for example, a millimeter wave radar, and detects an obstacle in the surroundings of the transport vehicle 20 with radio waves. In addition, the external sensor is, for example, Light Detection and Ranging (LIDAR), and detects an obstacle in the surroundings of the transport vehicle 20 with light. A control unit (ECU) 49 is capable of measuring a distance to an obstacle, by analyzing information that has been detected by the detection unit 480. It is possible to provide the external sensors respectively in a front part, a rear part, and left and right lateral parts of the transport vehicle 20. Thus, it becomes possible to monitor four directions of the transport vehicle 20.

The transport vehicle 20 includes a positioning sensor 410 and a communication device 420. The positioning sensor 410 receives a positioning signal from an artificial satellite that constitutes a global navigation satellite system (GNSS). An example of the GNSS is a global positioning system (GPS). The positioning sensor 410 receives a positioning signal (a GNSS signal, for example, a GPS signal), and detects the current position of the transport vehicle 20. The communication device 420 communicates (on wireless communication) with the server 30 to acquire information.

The transport vehicle 20 includes a control unit (ECU) 49. The control unit 49 includes a processor represented by a CPU, a storage device such as a semiconductor memory or a hard disk, and an interface with an external device. In the storage device, programs to be executed by the processor, data (map information) to be used by the processor for processing, and the like are stored. A plurality of sets of processors, storage devices, and interfaces may be provided for every function of the transport vehicle 20 so as to be capable of communicating with each other.

The control unit (ECU) 49 controls the electric traveling mechanism 42, and performs information processing of a detection result of the positioning sensor 410 and information processing of a communication result of the communication device 420.

Upon receipt of a movement instruction from the server 30, the control unit 49 controls traveling of the transport vehicle 20. The control unit 49 searches for a route from the current location (a departure place) to a destination, based on the map information. The communication device 420 is capable of acquiring the map information, by accessing a database of the server 30 on the network NW.

The transport vehicle 20 includes an image acquisition unit (a camera) 48, which acquires a surrounding image. As illustrated in FIG. 2, the image acquisition unit (the camera) 48 is provided, for example, in a front part of the transport vehicle 20, and acquires an image on a forward side, when the transport vehicle 20 travels. The control unit 49 is capable of controlling automated driving of the transport vehicle 20, with use of image information that has been acquired by the image acquisition unit (the camera) 48 or the map information that has been acquired by the communication device 420.

### (Server 30)

The server 30 includes a processing unit 31, a communication unit 32, and a storage unit 33, which are connected with each other through a bus, not illustrated. The processing unit 31 is a processor represented by a CPU, and executes a program stored in the storage unit 33 to implement various functions related to the server 30. That is, information processing by software stored in the storage unit 33 is specifically implemented by the processing unit 31, which is an example of hardware, and can be performed as each functional unit included in the processing unit 31. The storage unit 33 is, for example, a read only memory (ROM), a random access memory (RAM), a hard disk drive (HDD), or a solid state drive (SSD), and stores various types of data in addition to the programs to be executed by the processing unit 31. The communication unit 32 is a communication interface with an external device.

FIG. 3 is a diagram for describing a flow of processing in the server 30. In step S310, the server 30 acquires a transport request instruction from the terminal 40 via the communication unit 32.

In step S320, the processing unit 31 calculates priorities of a plurality of transported objects to be transported from a departure place to a destination, based on the transport request instruction acquired in S310.

Here, FIG. 4 is a diagram illustrating contents of the transport request instruction. Here, an example is illustrated in which a transported object A, a transported object B, and a transported object C are to be transported as the transported objects. However, the configuration in an embodiment is not limited to this example.

In the present embodiment, the plurality of transport vehicles 20 autonomously move between a departure place and at least one destination (for example, a construction site or the like), and transport tools, materials, and the like for use in the destination. In the example illustrated in FIG. 4, the transported object A is, for example, a tool (weight: 30 Kg), the transported object B is, for example, materials (weight: 100 Kg), and the transported object C is, for example, materials (weight: 200 Kg).

The transport request instruction illustrated in FIG. 4 includes an urgency degree indicating a degree that the transported object is necessary in the destination, and the processing unit 31 sets (calculates) higher priorities in descending order of the urgency degree. The urgency degree is set in three stages, for example, “high”, “medium”, and “low”, and the transported object A having the urgency degree “high” indicates that the transported object A has the highest degree that the transported object is necessary in the destination. In this case, the processing unit 31 calculates higher priorities in the order of higher urgency degrees (“high”, “medium”, and “low”).

In addition, the transport request instruction illustrated in FIG. 4 includes the time necessary for an unloading process of the transported object in the destination, and the processing unit 31 calculates a higher priority in the order of shorter time necessary for the unloading process. By setting a higher priority to a transported object of a shorter time necessary for the unloading process, even when a plurality of transport vehicles 20 arrive at the destination, the waiting time of waiting for unloading can be shortened. In the example of FIG. 4, the times necessary for the unloading process of the transported objects A, B, and C are respectively, for example, one minute, three minutes, and six minutes. In such a case, the processing unit 31 calculates higher priorities in the order of shorter times (one minute, three minutes, six minutes) necessary for the unloading process. The processing unit 31 sets the highest priority to the transported object A for which the time necessary for the unloading process is one minute. In addition, the processing unit 31 sets the second highest priority to the transported object B for which the time necessary for the unloading process is three minutes. Then, the processing unit 31 sets the lowest priority to the transported object C for which the time necessary for the unloading process is six minutes.

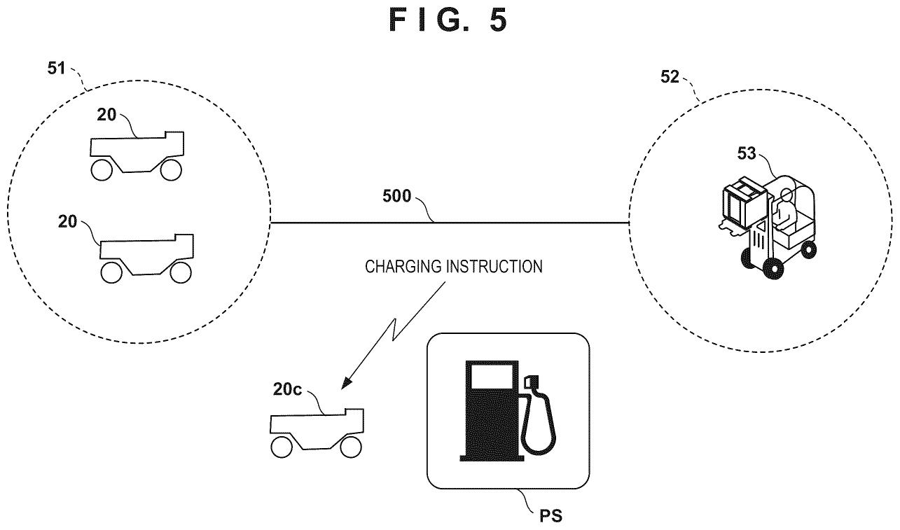

FIG. 5 is a diagram schematically illustrating a departure place 51, a destination 52, and a charging station PS. A route 500 indicates a route for moving from the departure place 51 to the destination 52. A plurality of transport vehicles 20 are on standby in the departure place 51, and start moving from the departure place 51 to the destination 52 at a timing when receiving a movement instruction from the server 30.

The transport request instruction illustrated in FIG. 4 includes information indicating a battery remaining amount of each of the plurality of transport vehicles 20. In a case where the battery remaining amount is smaller than a battery remaining amount necessary for making a round trip between the departure place 51 and the destination 52, the processing unit 31 calculates a lower priority. In such a case, out of the plurality of transport vehicles 20, the processing unit 31 outputs a charging instruction to charge at the charging station PS to a transport vehicle (20c in FIG. 5) having a battery remaining amount smaller than the battery remaining amount necessary for making the round trip between the departure place 51 and the destination 52. The transport vehicle 20c, which has received the charging instruction, is excluded from a transport assignment target at least until the battery remaining amount is enough for making the round trip between the departure place 51 and the destination 52. After the battery is charged to have the battery remaining amount enough for making the round trip, the transport vehicle 20c becomes the transport assignment target again. By excluding, from the assignment target beforehand, a transport vehicle having the battery remaining amount smaller than the battery remaining amount necessary for making the round trip between the departure place 51 and the destination 52, it becomes possible to suppress battery shortage (electricity shortage) while transporting the transported object, for example, on the way of the route 500.

In addition, the transport request instruction illustrated in FIG. 4 includes information about necessity or unnecessity of equipment (for example, a forklift truck 53) necessary for the unloading process of the transported object and presence or absence of the equipment (the forklift truck 53) capable of handling the unloading process in the destination 52. For example, “necessary” is set to a transported object for which the equipment for unloading the transported object from the transport vehicle 20 is necessary, and “unnecessary” is set to a transported object for which the equipment for unloading the transported object from the transport vehicle 20 is unnecessary.

With regard to a transported object for which the equipment for unloading the transported object is necessary, in a case where the equipment (the forklift truck 53) is on standby in a state of being capable of handling the unloading process in the destination 52, “presence” is set to the equipment. On the other hand, in a case where the equipment (the forklift truck 53) is not on standby in the state of being capable of handling the unloading process, “absence” is set to the equipment. Information about the necessity or unnecessity of the equipment (for example, a forklift truck or the like) necessary for the unloading process of the transported object and the presence or absence of the equipment capable of handling the unloading process is transmitted from the respective base office terminals in the departure place 51 and the destination 52 to the terminal 40. The terminal 40 acquires the information that has been transmitted from the respective base office terminals, as information that constitutes the transport request instruction.

In a case where there are a plurality of transported objects (for example, the transported object B and the transported object C in FIG. 4) for which the equipment is necessary, the processing unit 31 calculates a higher priority, based on the presence or absence of the equipment in the destination 52. In the example of FIG. 4, the equipment for unloading the transported object B is on standby in the destination 52 (setting of “presence”), and the processing unit 31 sets a higher priority to the transported object B than the transport of the transported object C.

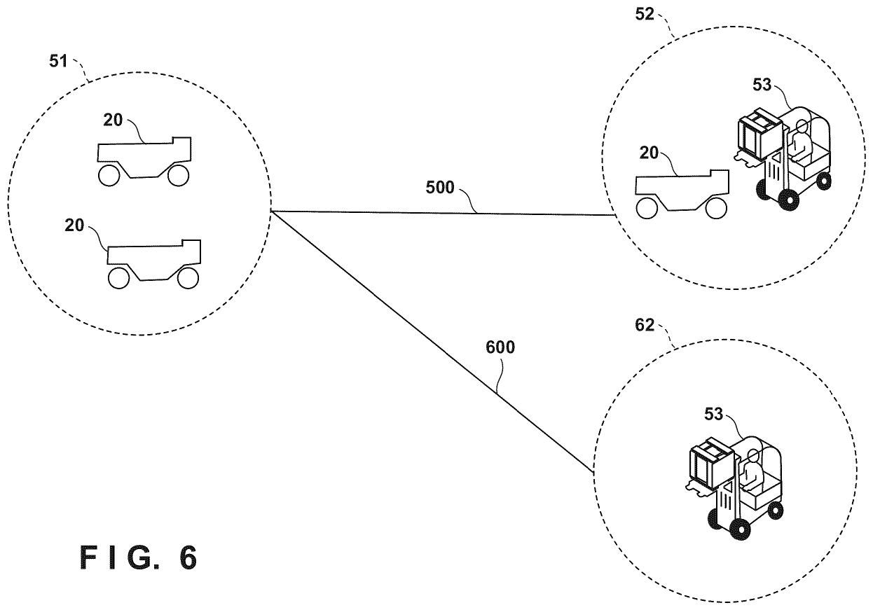

FIG. 6 is a diagram illustrating a case where a plurality of transported objects are respectively transported to a plurality of destinations 52 and 62. A route 500 indicates a route for moving from the departure place 51 to the destination 52, and a route 600 indicates a route for moving from the departure place 51 to the destination 62. In the departure place 51, a plurality of transport vehicles 20 are on standby in a state of being capable of transporting, and in the destination 52, a preceding transport vehicle 20 is unloading, and a congested situation is indicated. The destination 62 indicates a vacant state in which unloading is available.

The transport request instruction illustrated in FIG. 4 includes information indicating a congestion state in each of a plurality of destinations (for example, 52 and 62), and the processing unit 31 calculates a higher priority for a transported object to be directed to a destination indicating vacancy, based on the information indicating the congestion state. In the example of FIG. 4, for example, in a case where the destination of the transported object A is the destination 62 and the destinations of the transported object B and the transported object C are the destination 52, the processing unit 31 calculates a higher priority for the transported object A to be directed to the destination 62 indicating vacancy.

In such a case, the processing unit 31 sets priorities of the transported object B and the transported object C, based on the setting of the transport request instruction about the above-described urgency degree. In a case where there are a plurality of transported objects having identical urgency degrees, the processing unit 31 calculates a higher priority for a transported object having a shorter unloading time.

For transported objects having the same settings of the urgency degree and unloading time, a higher priority is calculated for a transported object for which the equipment for the unloading work is not necessary in the destination. In a case where the settings of the urgency degree and the unloading time are the same and the equipment for the unloading work is necessary for all of the transported objects, the processing unit 31 calculates priorities, based on whether the equipment is on standby in the destination. In such a case, the processing unit 31 calculates a higher priority for a transported object, the equipment for which is on standby in the destination.

In a case where there are a plurality of transported objects having the identical priorities, the processing unit 31 calculates a higher priority for a transported object to be directed to a destination indicating vacancy, based on the information indicating the congestion state.

Heretofore, the processing of step S320 ends, and the processing proceeds to the next step S330.

Referring back to FIG. 3, in step S330, the processing unit 31 assigns transport vehicles to transport a plurality of transported objects in accordance with the priorities from the transport vehicles in a state of being capable of transporting, out of the plurality of transport vehicles. In the transport request instruction illustrated in FIG. 4, two vehicles are available. For example, as illustrated in FIG. 5, the transport vehicles for transporting a plurality of transported objects are assigned in accordance with the priorities from the transport vehicles 20, which are in a state of being capable of transporting, out of the plurality of transport vehicles on standby in the departure place 51. For example, the processing unit 31 assigns the first transport vehicle 20 to transport the transported object A having the highest priority out of the plurality of transported objects A, B, and C illustrated in FIG. 4. Then, the processing unit 31 assigns the second transport vehicle 20 to transport the transported object B having the second highest priority out of the plurality of transported objects A, B, and C. In order to transport the transported object C having the lowest priority, after the charging process of the transport vehicle 20c is completed, the processing unit 31 assigns the third transport vehicle 20c.

In step S340, the processing unit 31 controls the movements by outputting movement instructions at predetermined timings respectively to the plurality of transport vehicles 20, which have been assigned by the processing in S330.

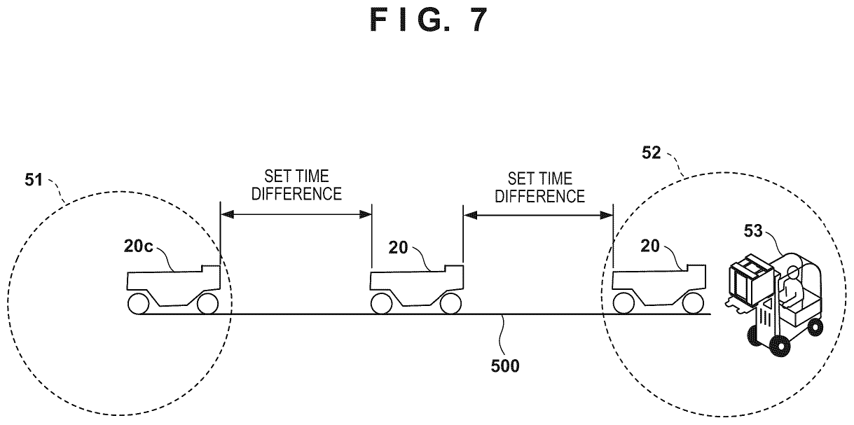

FIG. 7 is a diagram schematically illustrating the movement of each transport vehicle based on a movement instruction. Here, an example of moving from the departure place 51 to the destination 52 along the route 500 is illustrated. The processing unit 31 outputs movement instructions to provide a preset time difference in arrival time when the plurality of transport vehicles 20 arrive at the destination 52. For example, the processing unit 31 outputs the movement instruction at a timing when the preset time difference in arrival time at the destination 52 is ensured by adjusting departure times when the plurality of transport vehicles depart from the departure place 51. In addition, in order to ensure such a preset time difference in arrival time at the destination 52 after the departure from the departure place 51, the processing unit 31 may output, for example, an adjustment instruction of adjusting the moving speed to at least one transport vehicle (for example, the transport vehicle 20 (an intermediate transport vehicle) traveling on the route 500), out of the plurality of transport vehicles 20.

For example, in a case where the unloading work in the destination 52 is spending a predetermined time or longer, the processing unit 31 outputs an adjustment instruction of adjusting the moving speed to decelerate the moving speed to the transport vehicle 20 (the intermediate transport vehicle) in order to ensure the time difference that has been set. In addition, in a case where the unloading work in the destination 52 is completed in a shorter time than a predetermined scheduled time, the processing unit 31 outputs an adjustment instruction of adjusting the moving speed to accelerate the moving speed to the transport vehicle 20 (the intermediate transport vehicle) in order to ensure the time difference that has been set.

When the moving speed of the transport vehicle 20 (the intermediate transport vehicle) is adjusted, the processing unit 31 controls the timing of outputting the movement instruction in order to ensure the preset time difference in arrival time between the transport vehicle 20 (the intermediate transport vehicle) and the transport vehicle 20c.

### (Modifications)

In the above embodiments, an example of the movement of the transport vehicles 20 from the departure place (a loading place of the transported object) to the destination (the transport destination of the transported object) has been described. However, also when returning from the destination to the departure place, the processing unit 31 outputs a similar movement instruction in consideration of congestion in the departure place (the loading place of the transported object). That is, when the plurality of transport vehicles move from the destination to the departure place, the processing unit 31 outputs the movement instruction in order to provide a preset time difference in arrival time at the departure place.

The processing unit 31 is also capable of outputting a movement instruction at a timing when a time difference is ensured by adjusting departure times when the plurality of transport vehicles depart from the destination toward the departure place. In addition, after the plurality of transport vehicles depart from the destination toward the departure place, the processing unit 31 is also capable of outputting an adjustment instruction of adjusting the moving speed to at least one of the plurality of transport vehicles in order to ensure the preset time difference.

In addition, in a case where there are transport vehicles that depart from the departure place at substantially the same time, the processing unit 31 may set higher priorities for transported objects to be respectively directed to different destinations (for example, 52 and 62 in FIG. 6) and assign the transport vehicles to transport the respective transported objects in order to avoid the same destination.

### Summary of Embodiments

Configuration 1. A transport system (STM) comprising: a plurality of transport vehicles (20) capable of autonomously moving between a departure place and a destination; a terminal (40) used for inputting a transport request instruction including information about a plurality of transported objects to be respectively transported by the plurality of transport vehicles; and a server (30) capable of communicating with the plurality of transport vehicles and the terminal,
the server (30) comprising:
a calculation unit (31) configured to calculate priorities of the plurality of transported objects to be transported from the departure place to the destination, based on the transport request instruction;
an assignment unit (31) configured to assign, in accordance with the priorities, the plurality of transport vehicles to respectively transport the plurality of transported objects from transport vehicles in a state of being capable of transporting, out of the plurality of transport vehicles; and
a movement control unit (31) configured to output, at a predetermined timing, a movement instruction to each of the plurality of transport vehicles assigned by the assignment unit,
wherein the movement control unit (31) outputs the movement instruction to provide a preset time difference in arrival time when the plurality of transport vehicles arrive at the destination.

According to the transport system in the first configuration, it is possible to provide a transport technique capable of assigning a transport vehicle in accordance with the priority of a transported object and outputting a movement instruction to provide a time difference in arrival time when the transport vehicle arrives at a destination.

Configuration 2. The movement control unit (31) outputs the movement instruction at a timing when the time difference is ensured by adjusting departure times when the plurality of transport vehicles depart from the departure place.

According to the transport system in the configuration 2, by adjusting the departure times when the plurality of transport vehicles depart from the departure place and outputting the movement instruction at the timing when the time difference is ensured, it becomes possible to provide the time difference in arrival time when the transport vehicle arrives at the destination.

Configuration 3. The movement control unit (31) outputs an adjustment instruction of adjusting a moving speed to at least one of the plurality of transport vehicles to ensure the time difference after departure from the departure place.

According to the transport system in the configuration 3, by decelerating or accelerating the moving speed by the adjustment instruction of adjusting the moving speed, it becomes possible to make adjustment to provide the time difference in arrival time at the destination.

Configuration 4. The transport request instruction includes an urgency degree indicating a degree that each of the plurality of transported objects is necessary in the destination, and the calculation unit (31) calculates a higher priority in descending order of the urgency degree.

Configuration 5. The transport request instruction includes a time necessary for an unloading process of each of the plurality of transported objects in the destination, and the calculation unit (31) calculates a higher priority in ascending order of the time.

Configuration 6. The transport request instruction includes information indicating a battery remaining amount of each of the plurality of transport vehicles (20), and in a case where the battery remaining amount is smaller than a battery remaining amount necessary for making a round trip between the departure place and the destination, the calculation unit (31) calculates a lower priority.

According to the transport system in the configurations 4 to 6, the priority of each transported object can be calculated (set), based on the specific content of the transport request instruction.

Configuration 7. The movement control unit (31) outputs a charging instruction to a transport vehicle having the battery remaining amount smaller than the battery remaining amount necessary for making the round trip.

Configuration 8. The assignment unit (31) gives an assignment, by excluding the transport vehicle (20) having the battery remaining amount smaller than the battery remaining amount necessary for making the round trip.

According to the transport systems in the configurations 7 and 8, by excluding, from the assignment target beforehand, the transport vehicle with the battery having the battery remaining amount smaller than the battery remaining amount necessary for making the round trip between the departure place and the destination, it becomes possible to suppress the battery shortage while transporting the transported object, for example, on the way of the route.

Configuration 9. The transport request instruction includes information about necessity or unnecessity of equipment necessary for an unloading process of each of the plurality of transported objects in the destination and presence or absence of equipment capable of handling the unloading process, and
the calculation unit (31) calculates a higher priority, based on the presence or absence of the equipment, in a case where there are a plurality of transported objects for which the equipment is necessary.

Configuration 10. The transport request instruction includes information indicating a congestion state in each of a plurality of destinations, and the calculation unit (31) calculates a higher priority for a transported object to be directed to a destination indicating vacancy, based on the information.

Configuration 11. In a case where there are a plurality of transported objects respectively having identical priorities, the calculation unit (31) calculates the higher priority for the transported object to be directed to the destination indicating the vacancy, based on the information.

According to the transport system in the configurations 9 to 11, the priority of each transported object can be calculated (set), based on the specific content of the transport request instruction.

### Other Embodiments

In the present invention, it is also possible to supply a program for fulfilling the functions of the above-described embodiments to a system or a device that constitutes the system through a network or a storage medium, and one or more processors in a computer of such a device read the program to perform processing of a notification device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A transport system comprising: a plurality of transport vehicles capable of autonomously moving between a departure place and a destination; a terminal used for inputting a transport request instruction including information about a plurality of transported objects to be respectively transported by the plurality of transport vehicles; and a server capable of communicating with the plurality of transport vehicles and the terminal,
the server comprising:
a calculation unit configured to calculate priorities of the plurality of transported objects to be transported from the departure place to the destination, based on the transport request instruction;
an assignment unit configured to assign, in accordance with the priorities, the plurality of transport vehicles to respectively transport the plurality of transported objects from transport vehicles in a state of being capable of transporting, out of the plurality of transport vehicles; and
a movement control unit configured to output, at a predetermined timing, a movement instruction to each of the plurality of transport vehicles assigned by the assignment unit,
wherein the movement control unit outputs the movement instruction to provide a preset time difference in arrival time when the plurality of transport vehicles arrive at the destination.

2. The transport system according to claim 1, wherein the movement control unit outputs the movement instruction at a timing when the time difference is ensured by adjusting departure times when the plurality of transport vehicles depart from the departure place.

3. The transport system according to claim 1, wherein the movement control unit outputs an adjustment instruction of adjusting a moving speed to at least one of the plurality of transport vehicles to ensure the time difference after departure from the departure place.

4. The transport system according to claim 1, wherein the transport request instruction includes an urgency degree indicating a degree that each of the plurality of transported objects is necessary in the destination, and the calculation unit calculates a higher priority in descending order of the urgency degree.

5. The transport system according to claim 1, wherein the transport request instruction includes a time necessary for an unloading process of each of the plurality of transported objects in the destination, and the calculation unit calculates a higher priority in ascending order of the time.

6. The transport system according to claim 1, wherein the transport request instruction includes information indicating a battery remaining amount of each of the plurality of transport vehicles, and in a case where the battery remaining amount is smaller than a battery remaining amount necessary for making a round trip between the departure place and the destination, the calculation unit calculates a lower priority.

7. The transport system according to claim 6, wherein the movement control unit outputs a charging instruction to a transport vehicle having the battery remaining amount smaller than the battery remaining amount necessary for making the round trip.

8. The transport system according to claim 7, wherein the assignment unit gives an assignment, by excluding the transport vehicle having the battery remaining amount smaller than the battery remaining amount necessary for making the round trip.

9. The transport system according to claim 1, wherein
the transport request instruction includes information about necessity or unnecessity of equipment necessary for an unloading process of each of the plurality of transported objects in the destination and presence or absence of equipment capable of handling the unloading process, and
the calculation unit calculates a higher priority, based on the presence or absence of the equipment, in a case where there are a plurality of transported objects for which the equipment is necessary.

10. The transport system according to claim 1, wherein the transport request instruction includes information indicating a congestion state in each of a plurality of destinations, and the calculation unit calculates a higher priority for a transported object to be directed to a destination indicating vacancy, based on the information.

11. The transport system according to claim 10, wherein in a case where there are a plurality of transported objects respectively having identical priorities, the calculation unit calculates the higher priority for the transported object to be directed to the destination indicating the vacancy, based on the information.
